(19) United States
(12) Patent Application Publication
(10) Pub. No.: US 2026/0203861 A1
(43) Pub. Date: Jul. 16, 2026

(54) IMPLEMENTATION TECHNIQUES FOR ADAPTIVE DETAIL ENHANCEMENT OF IMAGES SYSTEMS AND METHODS

(71) Applicant: Teledyne FLIR Defense, Inc., Thousand Oaks, CA (US)

(72) Inventor: Kristine Skinner, Sherwood, OR (US)

(21) Appl. No.: 19/559,818

(22) Filed: Mar. 6, 2026

Related U.S. Application Data
(63) Continuation of application No. PCT/US2024/046783, filed on Sep. 13, 2024.
(60) Provisional application No. 63/582,492, filed on Sep. 13, 2023.

(51) Int. Cl. G06T 5/20; G06T 5/50; G06T 5/70

(52) U.S. Cl. CPC G06T 5/20; G06T 5/50; G06T 5/70; G06T 2207/20192; G06T 2207/20216; G06T 2207/20224

(57) ABSTRACT

Techniques are provided to adaptively enhance details of images. Systems and methods include receiving an input image having a plurality of pixels, performing a vertical guided filtering process on a column of pixels encompassing a center pixel to generate a vertical adjustment value, performing a horizontal guided filtering process on a row of pixels encompassing the center pixel to generate a horizontal adjustment value, adjusting the center pixel value in accordance with the vertical adjustment value and the horizontal adjustment value to generate a smoothed image, subtracting the smoothed image from the input image to create a detail image, and outputting an enhanced image.

### CROSS REFERENCE TO RELATED APPLICATIONS

This application is a continuation of International Patent Application No. PCT/US2024/046783 filed Sep. 13, 2024 and entitled “IMPLEMENTATION TECHNIQUES FOR ADAPTIVE DETAIL ENHANCEMENT OF IMAGES SYSTEMS AND METHODS,” which claims priority to and the benefit of U.S. Provisional Patent Application No. 63/582,492 filed Sep. 13, 2023 and entitled “IMPLEMENTATION TECHNIQUES FOR ADAPTIVE DETAIL ENHANCEMENT OF IMAGES SYSTEMS AND METHODS,” all of which are incorporated herein by reference in their entirety.

### TECHNICAL FIELD

The present invention relates generally to image processing and, more particularly, to adaptive detail enhancement of images.

### BACKGROUND

Various imaging processing devices may apply an unsharp masking method for image sharpening. Unsharp masking often includes applying a lowpass filter to an input image to create an unsharp (blurred) version of the image. The unsharp image is subtracted from the original image to extract high frequency details. The result is then multiplied by a user selectable gain factor, thereby boosting edges and details within the image. The boosted details are then added back into the input image, resulting in a sharpened output image.

A guided filter can be a more sophisticated alternative for blurring an image that better preserves edges. A guided filter can be implemented by first finding linear coefficients for each pixel in the input image, and then using the linear coefficients to generate output pixels, where the linear coefficients are computed over a window centered at a pixel that supports a smoothing filter.

These various techniques may utilize different amounts of processing resources and/or other factors. As a result, applying only a single processing technique without discretion may result in inefficient allocation of processing resources and/or other drawbacks.

### SUMMARY

The present disclosure provides improved implementation techniques for adaptive detail enhancement of images.

In various embodiments, a method includes receiving an input image comprising a plurality of pixels arranged in rows and columns; performing a vertical guided filtering process comprising processing a column of pixels encompassing a center pixel to generate a vertical adjustment value; performing a horizontal guided filtering process comprising processing a row of pixels encompassing the center pixel to generate a horizontal adjustment value; adjusting the center pixel value in accordance with the vertical adjustment value and the horizontal adjustment value to generate a smoothed image; subtracting the smoothed image from the input image to create a detail image; and outputting an enhanced image.

The method may further include providing adaptive detail enhancement of the contrast-adjusted image when the input image is a contrast-adjusted image, and/or generating the smoothed image with enhanced edges from the input image. In some embodiments, the method includes blending based at least in part on the vertical adjustment value and the horizontal adjustment value; and/or scaling the detail image by a configurable gain value. The enhanced image may be generated by combining the scaled detail image with the input image. In some embodiments, performing a vertical guided filtering process and performing a horizontal guided filtering process are performed in parallel.

In various embodiments, a system includes an image processing block comprising a line buffer configured to extract a matrix of pixels from an input image centered on a center pixel, a guided filter configured to process a horizontal row and a vertical column of pixels from the matrix of pixels, and an output adjustment block configured to adjust a value of the center pixel based on the outputs of the guided filter. The image processing block may further include a first-in, first out (FIFO) input buffer configured to receive pixels of the input image, wherein the line buffer extracts the matrix of pixels from the FIFO input buffer, and a FIFO output buffer configured to buffer adjusted pixel values for the image for output. In some embodiments, the system further includes a Tenegrad module configured to evaluate pixel values from the line buffer for autofocus processing.

The guided filter may include a horizontal guided filter configured to filter the horizontal row of pixels, and a vertical guided filter configured to filter the vertical row of pixels, wherein the horizontal guided filter and vertical guided filter operate in parallel. The guided filter may include a long vertical filter configured to process a vertical column of pixels encompassing the center pixel, a short vertical filter configured to process a subset of the vertical column of pixels, a long horizontal filter configured to process a horizontal row of pixels encompassing the center pixel, and a short horizontal filter configured to process a subset of the horizontal row of pixels.

The system may operate a method including loading input pixels of an input image into the line buffer, processing horizontal vectors of pixels from the line buffer and vertical vectors of pixels from the line buffer in parallel through the guided filter, and refining the value of the center pixel using the output adjustment block. The system may further include a plurality of delay elements implementing on one or more processing paths of the image processing block to match processing path lengths to synchronize processing.

In various embodiments, a system includes a guided horizontal filter, a guided vertical filter, an output adjustment module configured to combine the guided horizontal filter value and the guided vertical filter value, a subtraction component configured to subtract average guided filter outputs from a center pixel to generate a delta, a gain application module configured to apply a gain to the delta to generate a gain-adjusted delta; and an addition component configured to add the gain-adjusted delta to the center pixel value. The system may further include a saturation and conversion module configured to saturate and convert the center pixel value to an unsigned value, and/or delay elements configured to synchronize processing.

In various embodiments, a method includes buffering lines of incoming image data for an image frame; windowing over the image frame with an N×N matrix of pixels relative to a center pixel; extracting the center pixel, a long horizontal vector of length N centered on the center pixel, a short horizontal vector comprising a subset of pixels from the long horizontal vector, a long vertical vector of length N centered on the center pixel, and a short vertical vector comprising a subset of pixels from the long vertical vector; calculating a horizontal guided filter from the long horizontal vector and the short horizontal vector; calculating a vertical guided filter in parallel with the calculating the horizontal guided filter from the long vertical vector and the short vertical vector; averaging the calculated horizontal guided filter and the calculated vertical guided filter; subtracting the average from the center pixel to generate a delta; and multiplying the delta by a details gain value and adding to the center pixel value.

The scope of the invention is defined by the claims, which are incorporated into this section by reference. A more complete understanding of embodiments of the present invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

FIG. 1 illustrates a block diagram of an imaging system, in accordance with an embodiment of the disclosure.

FIG. 2 illustrates a block diagram of an image capture component, in accordance with an embodiment of the disclosure.

FIG. 3 illustrates an image frame with associated first and second window kernels, in accordance with an embodiment of the disclosure.

FIG. 4 illustrates a process of adaptively enhancing details of images, in accordance with an embodiment of the disclosure.

FIG. 5 illustrates another process of adaptively enhancing details of images, in accordance with an embodiment of the disclosure.

FIG. 6 illustrates a top-level block diagram of an example IP block, in accordance with embodiments of the present disclosure.

FIG. 7 is a block diagram illustrating an example video data streaming IP block, in accordance with one or more embodiments of the present disclosure.

FIG. 8 illustrates an example operation of a guided filter, in accordance with one or more embodiments of the present disclosure.

FIGS. 9A and 9B illustrate an example signal flow for both the horizontal guided filter and vertical guided filter, in accordance with one or more embodiments of the present disclosure.

FIG. 10 is a block diagram illustrating example output adjustments including delay elements, in accordance with one or more embodiments.

FIG. 11 is a flow diagram illustrating an example operation of ADE processing, in accordance with one or more embodiments of the present disclosure.

FIG. 12 is a flow diagram illustrating an example operation of a guided filter, in accordance with one or more embodiments of the present disclosure.

Embodiments of the present invention and their advantages are best understood by referring to the detailed description that follows. It should be appreciated that like reference numerals are used to identify like elements illustrated in one or more of the figures.

### DETAILED DESCRIPTION

Embodiments of the present disclosure provide systems and methods for adaptive detail enhancement of images to create a sharpened image. Embodiments may be based on unsharp masking principles for image sharpening plus a guided filter operation for an image blur process step to achieve improved visual results in a computationally efficient way (e.g., decreased computational complexity and latency). Embodiments may be adaptive to local characteristics of the image in a small neighborhood of each processed pixel.

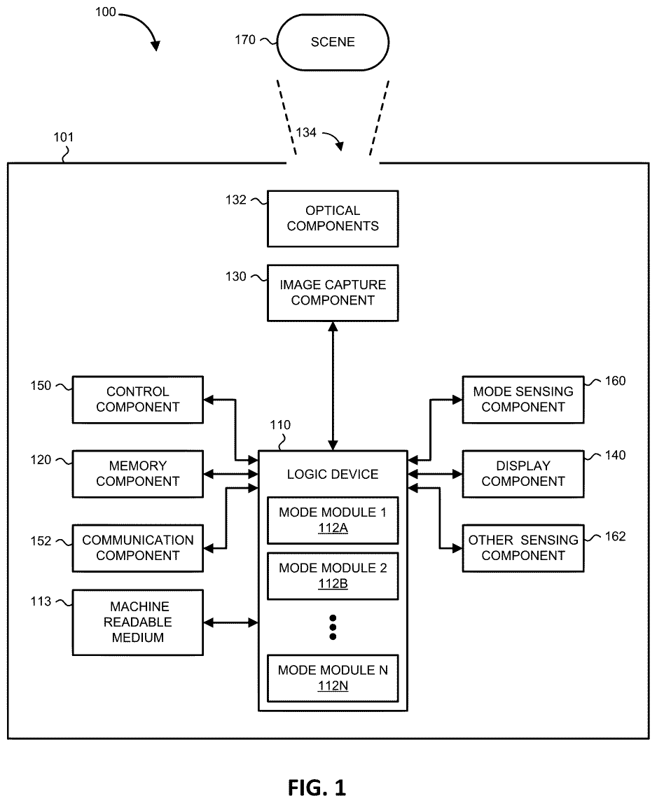

FIG. 1 illustrates a block diagram of an imaging system 100 in accordance with an embodiment of the disclosure. Imaging system 100 may be used to capture and process image frames in accordance with various techniques described herein. In one embodiment, various components of imaging system 100 may be provided in a housing 101, such as a housing of a camera, a personal electronic device (e.g., a mobile phone), or other system. In another embodiment, one or more components of imaging system 100 may be implemented remotely from each other in a distributed fashion (e.g., networked or otherwise).

In one embodiment, imaging system 100 includes a logic device 110, a memory component 120, an image capture component 130, optical components 132 (e.g., one or more lenses configured to receive electromagnetic radiation through an aperture 134 in housing 101 and pass the electromagnetic radiation to image capture component 130), a display component 140, a control component 150, a communication component 152, a mode sensing component 160, and a sensing component 162.

In various embodiments, imaging system 100 may implemented as an imaging device, such as a camera, to capture image frames, for example, of a scene 170 (e.g., a field of view). Imaging system 100 may represent any type of camera system which, for example, detects electromagnetic radiation (e.g., irradiance) and provides representative data (e.g., one or more still image frames or video image frames). For example, imaging system 100 may represent a camera that is directed to detect one or more ranges (e.g., wavebands) of electromagnetic radiation and provide associated image data. Imaging system 100 may include a portable device and may be implemented, for example, as a handheld device and/or coupled, in other examples, to various types of vehicles (e.g., a land-based vehicle, a watercraft, an aircraft, a spacecraft, or other vehicle) or to various types of fixed locations (e.g., a home security mount, a campsite or outdoors mount, or other location) via one or more types of mounts. In still another example, imaging system 100 may be integrated as part of a non-mobile installation to provide image frames to be stored and/or displayed.

Logic device 110 may include, for example, an FPGA (Field Programmable Gate Array), ASIC (Application Specific Integrated Circuit), GPU (Graphics Processing Unit) and/or or any other appropriate combination of processing device and/or memory to execute instructions to perform any of the various operations described herein. Logic device 110 is adapted to interface and communicate with components 120, 130, 140, 150, 160, and 162 to perform method and processing steps as described herein. Logic device 110 may include one or more mode modules 112A-112N for operating in one or more modes of operation (e.g., to operate in accordance with any of the various embodiments disclosed herein). In one embodiment, mode modules 112A-112N are adapted to define processing and/or display operations that may be embedded in logic device 110 or stored on memory component 120 for access and execution by logic device 110. In another aspect, logic device 110 may be adapted to perform various types of image processing techniques as described herein.

In various embodiments, it should be appreciated that each mode module 112A-112N may be integrated in software and/or hardware as part of logic device 110, or code (e.g., software or configuration data) for each mode of operation associated with each mode module 112A-112N, which may be stored in memory component 120. Embodiments of mode modules 112A-112N (i.e., modes of operation) disclosed herein may be stored by a machine readable medium 113 in a non-transitory manner (e.g., a memory, a hard drive, a compact disk, a digital video disk, or a flash memory) to be executed by a computer (e.g., logic or processor-based system) to perform various methods disclosed herein.

In various embodiments, the machine readable medium 113 may be included as part of imaging system 100 and/or separate from imaging system 100, with stored mode modules 112A-112N provided to imaging system 100 by coupling the machine readable medium 113 to imaging system 100 and/or by imaging system 100 downloading (e.g., via a wired or wireless link) the mode modules 112A-112N from the machine readable medium (e.g., containing the non-transitory information). In various embodiments, as described herein, mode modules 112A-112N provide for improved camera processing techniques for real time applications, wherein a user or operator may change the mode of operation depending on a particular application, such as an off-road application, a maritime application, an aircraft application, a space application, or other application.

Memory component 120 includes, in one embodiment, one or more memory devices (e.g., one or more memories) to store data and information. The one or more memory devices may include various types of memory including volatile and non-volatile memory devices, such as RAM (Random Access Memory), ROM (Read-Only Memory), EEPROM (Electrically-Erasable Read-Only Memory), flash memory, or other types of memory. In one embodiment, logic device 110 is adapted to execute software stored in memory component 120 and/or machine-readable medium 113 to perform various methods, processes, and modes of operations in manner as described herein.

Image capture component 130 includes, in one embodiment, one or more sensors (e.g., any type of visible light, infrared, and/or any other type of electro-optical detector, or other type of detector, including a detector implemented as part of a focal plane array) for capturing image signals representative of an image of scene 170. In one embodiment, the sensors of image capture component 130 provide for representing (e.g., converting) a captured thermal image signal of scene 170 as digital data (e.g., via an analog-to-digital converter included as part of the sensor or separate from the sensor as part of imaging system 100).

Logic device 110 may be adapted to receive image signals from image capture component 130, process image signals (e.g., to provide processed image data), store image signals or image data in memory component 120, and/or retrieve stored image signals from memory component 120. Logic device 110 may be adapted to process image signals stored in memory component 120 to provide image data (e.g., captured and/or processed image data) to display component 140 for viewing by a user.

Display component 140 includes, in one embodiment, an image display device (e.g., a liquid crystal display (LCD)) or various other types of generally known video displays or monitors. Logic device 110 may be adapted to display image data and information on display component 140. Logic device 110 may be adapted to retrieve image data and information from memory component 120 and display any retrieved image data and information on display component 140. Display component 140 may include display electronics, which may be utilized by logic device 110 to display image data and information. Display component 140 may receive image data and information directly from image capture component 130 via logic device 110, or the image data and information may be transferred from memory component 120 via logic device 110.

In one embodiment, logic device 110 may initially process a captured thermal image frame and present a processed image frame in one mode, corresponding to mode modules 112A-112N, and then upon user input to control component 150, logic device 110 may switch the current mode to a different mode for viewing the processed image frame on display component 140 in the different mode. This switching may be referred to as applying the camera processing techniques of mode modules 112A-112N for real time applications, wherein a user or operator may change the mode while viewing an image frame on display component 140 based on user input to control component 150. In various aspects, display component 140 may be remotely positioned, and logic device 110 may be adapted to remotely display image data and information on display component 140 via wired or wireless communication with display component 140, as described herein.

Control component 150 includes, in one embodiment, a user input and/or interface device having one or more user actuated components, such as one or more push buttons, slide bars, rotatable knobs or a keyboard, that are adapted to generate one or more user actuated input control signals. Control component 150 may be adapted to be integrated as part of display component 140 to operate as both a user input device and a display device, such as, for example, a touch screen device adapted to receive input signals from a user touching different parts of the display screen. Logic device 110 may be adapted to sense control input signals from control component 150 and respond to any sensed control input signals received therefrom.

Control component 150 may include, in one embodiment, a control panel unit (e.g., a wired or wireless handheld control unit) having one or more user-activated mechanisms (e.g., buttons, knobs, sliders, or others) adapted to interface with a user and receive user input control signals. In various embodiments, the one or more user-activated mechanisms of the control panel unit may be utilized to select between the various modes of operation, as described herein in reference to mode modules 112A-112N. In other embodiments, it should be appreciated that the control panel unit may be adapted to include one or more other user-activated mechanisms to provide various other control operations of imaging system 100, such as auto-focus, menu enable and selection, field of view (FoV), brightness, contrast, gain, offset, spatial, temporal, and/or various other features and/or parameters. In still other embodiments, a variable gain signal may be adjusted by the user or operator based on a selected mode of operation.

In another embodiment, control component 150 may include a graphical user interface (GUI), which may be integrated as part of display component 140 (e.g., a user actuated touch screen), having one or more images of the user-activated mechanisms (e.g., buttons, knobs, sliders, or others), which are adapted to interface with a user and receive user input control signals via the display component 140. As an example for one or more embodiments as discussed further herein, display component 140 and control component 150 may represent appropriate portions of a smart phone, a tablet, a personal digital assistant (e.g., a wireless, mobile device), a laptop computer, a desktop computer, or other type of device.

Mode sensing component 160 includes, in one embodiment, an application sensor adapted to automatically sense a mode of operation, depending on the sensed application (e.g., intended use or implementation), and provide related information to logic device 110. In various embodiments, the application sensor may include a mechanical triggering mechanism (e.g., a clamp, clip, hook, switch, push-button, or others), an electronic triggering mechanism (e.g., an electronic switch, push-button, electrical signal, electrical connection, or others), an electromechanical triggering mechanism, an electro-magnetic triggering mechanism, or some combination thereof. For example for one or more embodiments, mode sensing component 160 senses a mode of operation corresponding to the imaging system's 100 intended application based on the type of mount (e.g., accessory or fixture) to which a user has coupled the imaging system 100 (e.g., image capture component 130). Alternatively, the mode of operation may be provided via control component 150 by a user of imaging system 100 (e.g., wirelessly via display component 140 having a touch screen or other user input representing control component 150).

Furthermore, in accordance with one or more embodiments, a default mode of operation may be provided, such as for example when mode sensing component 160 does not sense a particular mode of operation (e.g., no mount sensed or user selection provided). For example, imaging system 100 may be used in a freeform mode (e.g., handheld with no mount) and the default mode of operation may be set to handheld operation, with the image frames provided wirelessly to a wireless display (e.g., another handheld device with a display, such as a smart phone, or to a vehicle's display).

Mode sensing component 160, in one embodiment, may include a mechanical locking mechanism adapted to secure the imaging system 100 to a vehicle or part thereof and may include a sensor adapted to provide a sensing signal to logic device 110 when the imaging system 100 is mounted and/or secured to the vehicle. Mode sensing component 160, in one embodiment, may be adapted to receive an electrical signal and/or sense an electrical connection type and/or mechanical mount type and provide a sensing signal to logic device 110. Alternatively, or in addition, as discussed herein for one or more embodiments, a user may provide a user input via control component 150 (e.g., a wireless touch screen of display component 140) to designate the desired mode (e.g., application) of imaging system 100.

Logic device 110 may be adapted to communicate with mode sensing component 160 (e.g., by receiving sensor information from mode sensing component 160) and image capture component 130 (e.g., by receiving data and information from image capture component 130 and providing and/or receiving command, control, and/or other information to and/or from other components of imaging system 100).

In various embodiments, mode sensing component 160 may be adapted to provide data and information relating to system applications including a handheld implementation and/or coupling implementation associated with various types of vehicles (e.g., a land-based vehicle, a watercraft, an aircraft, a spacecraft, or other vehicle) or stationary applications (e.g., a fixed location, such as on a structure). In one embodiment, mode sensing component 160 may include communication devices that relay information to logic device 110 via wireless communication. For example, mode sensing component 160 may be adapted to receive and/or provide information through a satellite, through a local broadcast transmission (e.g., radio frequency), through a mobile or cellular network and/or through information beacons in an infrastructure (e.g., a transportation or highway information beacon infrastructure) or various other wired or wireless techniques (e.g., using various local area or wide area wireless standards).

In another embodiment, imaging system 100 may include one or more other types of sensing components 162, including environmental and/or operational sensors, depending on the sensed application or implementation, which provide information to logic device 110 (e.g., by receiving sensor information from each sensing component 162). In various embodiments, other sensing components 162 may be adapted to provide data and information related to environmental conditions, such as internal and/or external temperature conditions, lighting conditions (e.g., day, night, dusk, and/or dawn), humidity levels, specific weather conditions (e.g., sun, rain, and/or snow), distance (e.g., laser rangefinder), and/or whether a tunnel, a covered parking garage, or that some type of enclosure has been entered or exited. Accordingly, other sensing components 160 may include one or more conventional sensors as would be known by those skilled in the art for monitoring various conditions (e.g., environmental conditions) that may have an effect (e.g., on the image appearance) on the data provided by image capture component 130.

In some embodiments, other sensing components 162 may include devices that relay information to logic device 110 via wireless communication. For example, each sensing component 162 may be adapted to receive information from a satellite, through a local broadcast (e.g., radio frequency) transmission, through a mobile or cellular network and/or through information beacons in an infrastructure (e.g., a transportation or highway information beacon infrastructure) or various other wired or wireless techniques. In some embodiments, other sensing components 162 may include one or more motion sensors (e.g., accelerometers, gyroscopes, micro-electromechanical system (MEMS) devices, and/or others as appropriate).

In various embodiments, components of imaging system 100 may be combined and/or implemented or not, as desired or depending on application requirements, with imaging system 100 representing various operational blocks of a system. For example, logic device 110 may be combined with memory component 120, image capture component 130, display component 140, and/or mode sensing component 160. In another example, logic device 110 may be combined with image capture component 130 with only certain operations of logic device 110 performed by circuitry (e.g., a processor, a microprocessor, a microcontroller, a logic device, or other circuitry) within image capture component 130. In still another example, control component 150 may be combined with one or more other components or be remotely connected to at least one other component, such as logic device 110, via a wired or wireless control device so as to provide control signals thereto.

In some embodiments, communication component 152 may be implemented as a network interface component (NIC) adapted for communication with a network including other devices in the network. In various embodiments, communication component 152 may include a wireless communication component, such as a wireless local area network (WLAN) component based on the IEEE 802.11 standards, a wireless broadband component, mobile cellular component, a wireless satellite component, or various other types of wireless communication components including radio frequency (RF), microwave frequency (MWF), and/or infrared frequency (IRF) components adapted for communication with a network. As such, communication component 152 may include an antenna coupled thereto for wireless communication purposes. In other embodiments, the communication component 152 may be adapted to interface with a DSL (e.g., Digital Subscriber Line) modem, a PSTN (Public Switched Telephone Network) modem, an Ethernet device, and/or various other types of wired and/or wireless network communication devices adapted for communication with a network.

In various embodiments, a network may be implemented as a single network or a combination of multiple networks. For example, in various embodiments, the network may include the Internet and/or one or more intranets, landline networks, wireless networks, and/or other appropriate types of communication networks. In another example, the network may include a wireless telecommunications network (e.g., cellular phone network) adapted to communicate with other communication networks, such as the Internet. As such, in various embodiments, the imaging system 100 may be associated with a particular network link such as for example a URL (Uniform Resource Locator), an IP (Internet Protocol) address, and/or a mobile phone number.

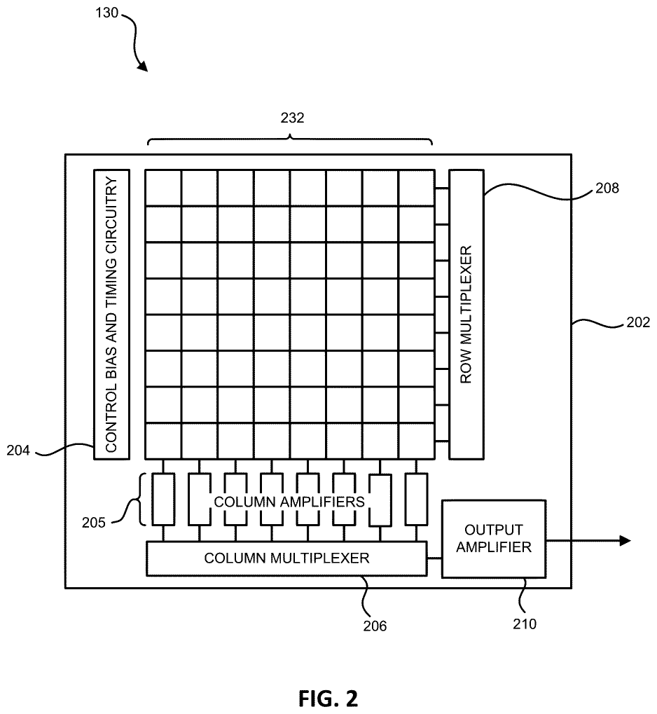

FIG. 2 illustrates a block diagram of image capture component 130 in accordance with an embodiment of the disclosure. In this illustrated embodiment, image capture component 130 is a thermal imager implemented as a focal plane array (FPA) including an array of unit cells 232 and a read out integrated circuit (ROIC) 202. Each unit cell 232 may be provided with an infrared detector (e.g., a microbolometer or other appropriate sensor) and associated circuitry to provide image data for a pixel of a captured thermal image frame. In this regard, time-multiplexed electrical signals may be provided by the unit cells 232 to ROIC 202.

ROIC 202 includes bias generation and timing control circuitry 204, column amplifiers 205, a column multiplexer 206, a row multiplexer 208, and an output amplifier 210. Image frames captured by infrared sensors of the unit cells 232 may be provided by output amplifier 210 to logic device 110 and/or any other appropriate components to perform various processing techniques described herein. Although an 8 by 8 array is shown in FIG. 2, any desired array configuration may be used in other embodiments. Further descriptions of ROICs and infrared sensors (e.g., microbolometer circuits) may be found in U.S. Pat. No. 6,028,309 issued Feb. 22, 2000, which is incorporated by reference herein in its entirety.

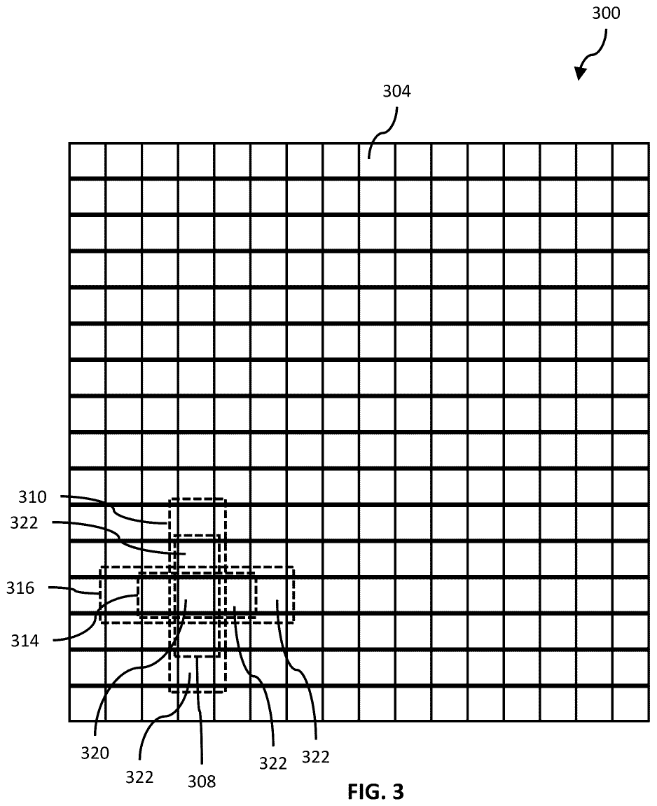

FIG. 3 illustrates an image frame 300 (e.g., provided by image capture component 130), in accordance with an embodiment of the disclosure. Although image frame 300 is represented as a 16 by 16 pixel image frame, any desired size may be used. As shown, image frame 300 includes a plurality of pixels 304 arranged in columns and rows. In accordance with the techniques discussed herein, various groups (e.g., sets or neighborhoods) of pixels 304 may be identified, also referred to as kernels or windows. The kernels or windows may be associated with a row and column of pixels 304. For example, FIG. 3 identifies a first vector 308,second vector 310, a third vector 314, and a fourth vector 316 that together make up a kernel within 304. The vectors 308, 310, 314 and 316 may be of various sizes, such as of the same size or of different sizes to each other. For example, as shown, first window 308 is a 3×1 pixel kernel, and second window 310 is a 5×1 pixel kernel, third window 314 is a 1×3 pixel kernel, and fourth window 316 is a 1×5 pixel kernel, although other configurations are contemplated.

Each window may include a grid of pixels 304 having a center pixel 320 and neighbor pixels 322. For example, first vector 308 includes a center pixel 320 and two vertically adjacent neighbor pixels 322, second vector 310 includes a center pixel 320 and four vertically adjacent neighbor pixels 322, third vector 314 includes a center pixel 320 and two horizontally adjacent neighbor pixels 322, and fourth vector 316 includes a center pixel 320 and four horizontally adjacent neighbor pixels 322. In embodiments, first, second, third and fourth vectors 308, 310, 314, 316 may share the same center pixel 320. Although the kernel size5×5 is shown, different kernel sizes may be used in any embodiments discussed herein as appropriate. In some embodiments, first vector 308 includes a vector size smaller than second window 310. Similarly, third vector 314 may include a vector size smaller than fourth window 316.

As described in more detail below, first vector 308, second vector 310, third vector 314, and/or fourth vector 316 may be used to apply one or more imaging effects, such as blurring, sharpening, or edge detection, based on pixel values of the center pixel 320 compared to neighboring pixels 322. In embodiments, each of first window 308 and second window 310 may slide vertically along one or more columns of image frame 300 to support adaptive enhancement of one or more details in image frame 300, as described in detail below. Similarly, each of third window 314 and fourth window 316 may slide horizontally along one or more rows of image frame 300 to support adaptive enhancement of one or more details in image frame 300, as detailed below. For example, the differences in image processing values associated between first window 308 and second window 310 and/or the differences in image processing values associated between third window 314 and fourth window 316 may be used to smooth an input image for creating a sharpened image, as detailed below.

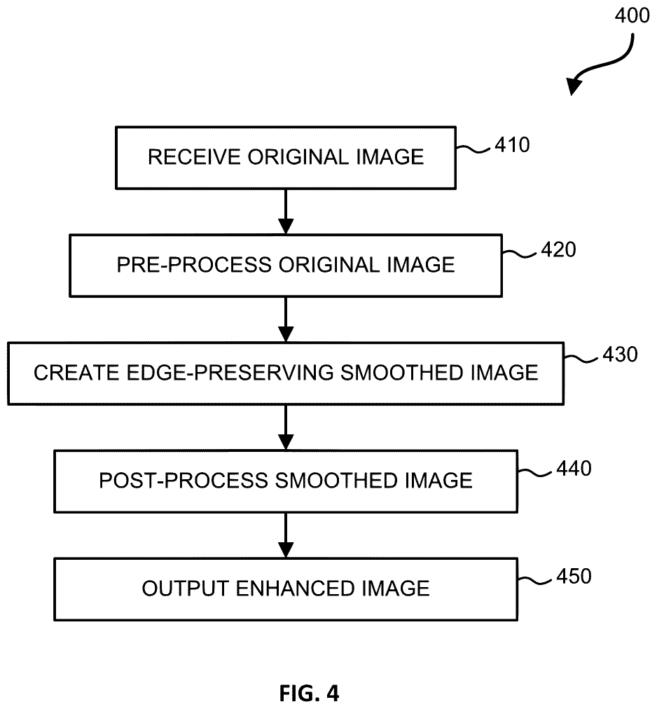

FIG. 4 illustrates a process 400 of adaptively enhancing details of images, in accordance with an embodiment of the disclosure. In embodiments, process 400 may be performed by logic device 110 of imaging system 100, such as an image processing pipeline provided by logic device 110. In some embodiments, process 400 may be performed during runtime operation of imaging system 100 to permit real-time image/edge sharpening of IR and EO imagery. Note that one or more operations in FIG. 4 may be combined, omitted, and/or performed in a different order as desired.

In block 410, process 400 includes receiving an original image. For instance, imaging system 100 may capture the original image, such as image capture component 130 capturing image signals representative of an image of scene 170. The image signals from image capture component 130 may be received by logic device 110, such as in a manner as described above with reference to FIG. 1. In embodiments, the original image may be captured by a different system, device or module and passed to the logic device 110 in other manners (e.g., via wired or wireless communication or the like).

In block 420, process 400 includes pre-processing the original image. In embodiments, block 420 includes contrast-stretching the original image to create a contrast-adjusted image or frame. The contrast-adjusted image/frame may be created using a variety of methods, including, but not limited to, linear or nonlinear scaling of image pixel values from a minimum value to a maximum value and saturating the pixel values above or below the minimum and maximum values, respectively. This process can be applied globally, locally, or a combination of both globally and locally. The above embodiments are illustrative only, and block 420 may include other methods of pre-processing the original image.

In block 430, process 400 includes creating an edge-preserving smoothed image that exhibits reduced detail in relation to original image. In embodiments, block 430 includes applying a two-dimensional (2D) guided filter to the original image and/or the pre-processed image (i.e., a base or input image) to create a filtered image. For instance, block 430 may include applying vertical and horizontal one-dimensional (1D) filters to the base image, which can be done in parallel or otherwise performed independent from each other. The vertical and horizontal 1D filters operate independently on the same input image and therefore affect the input image in similar, unbiased ways. For example, the base image may be vertically filtered and processed, and horizontally filtered and processed in parallel or otherwise independent from each other. Depending on the application, each 1D filter may utilize a box filter, a triangle filter, or a Gaussian, or other, low-pass filter.

In embodiments, block 430 may include using parameters to guide a per-pixel blending of the filtered image with the original image or the pre-processed image in each of the vertical and horizontal dimensions. The per-pixel blending in each of the vertical and horizontal dimensions may be performed in parallel. The vertically and horizontally blended images may be combined to create the smoothed image. For example, the vertically blended image and the horizontally blended image may be averaged to produce the smoothed image.

In block 440, process 400 includes post-processing the smoothed image. In block 440, a detail image may be produced based on a difference between the smoothed image and the base image, the detail image providing enhanced and/or sharpened details in relation to the original image (e.g., enhanced details of scene 170). For instance, the smoothed image may be subtracted from the base image to create the detail image, although other methods are contemplated. In embodiments, block 440 may include scaling the detail image by a gain value (e.g., to produce a scaled detail image). In embodiments, block 440 may include combining the base image with the scaled detail image (e.g., to produce an enhanced image). In embodiments, block 440 may include other post-processing steps. For example, block 440 may include adjusting the enhanced image by a brightness value.

In block 450, process 400 includes outputting the enhanced image. For example, the enhanced image may be outputted to display component 140 of imaging system 100. In embodiments, block 450 may include outputting the enhanced image to a separate device, system, or module.

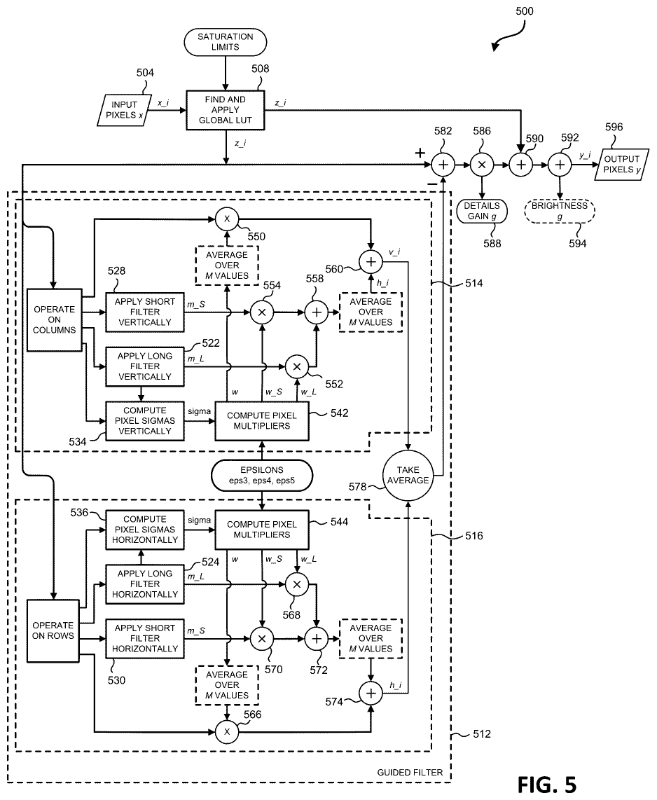

FIG. 5 illustrates another process 500 of adaptively enhancing details of images, in accordance with an embodiment of the disclosure. In embodiments, process 500 may be performed by logic device 110 of imaging system 100, such as an image processing pipeline provided by logic device 110. In some embodiments, process 500 may be performed during runtime operation of imaging system 100 to permit real-time image/edge sharpening of IR and EO imagery. Note that one or more operations in FIG. 5 may be combined, omitted, and/or performed in a different order as desired. In embodiments, process 500 provides further details of process 400 of FIG. 4, described above.

In block 504, process 500 includes receiving input pixels xᵢ of an input image. For example, block 504 may include receiving input pixels xᵢ from the original image received in block 410 of FIG. 4, described above.

In embodiments, process 500 includes one or more pre-processing steps or processes, such as in a manner as described above with reference to block 420 of FIG. 4. For example, in block 508, process 500 includes finding and applying a histogram modification to the input pixels xᵢ to generate adjusted pixels zᵢ. For instance, block 508 may include contrast-stretching the input pixels xᵢ, such as in block 420 of FIG. 4, described above. In embodiments, block 508 may include finding and applying a LUT to the input pixels xᵢ. For example, a LUT may be created to map pixel values of the input image to new values, so that a histogram of the result fills the full display range of the image's bit depth, and in a way that distributes the pixel values for further processing. In embodiments, block 508 may include computing an intermediate output (e.g., zᵢ=LUT(xᵢ)) at each pixel index i. In embodiments, block 508 may receive saturation limits to control the histogram modification of the input pixels xᵢ.

In block 512, process 500 includes performing a guided filter operation, such as in a manner as described above with reference to block 430 of FIG. 4, to produce a smoothed image that exhibits reduced detail in relation to base image. For example, block 512 may receive a base image including a plurality of base pixels (e.g., input pixels xᵢ or adjusted pixels zᵢ) arranged in rows and columns, and process the base image to produce a smoothed image. As shown, block 512 includes performing filtering and/or processing operations of the adjusted pixels zᵢ in two dimensions (e.g., along the rows and columns of the base image), with filtering in each dimension preferably performed independently (e.g., in parallel) and then combined to produce the smoothed image. For example, in block 514, process 500 may include performing a first filtering along at least one column of the base image (e.g., a column-wise filtering process). In block 516, process 500 may include performing a second filtering along at least one row of the base image (e.g., a row-wise filtering process). In embodiments, the row-wise filtering process may be performed independent from the column-wise filtering process (e.g., independent from each other), as detailed below. Although illustrated as performing filtering and/or processing operations of the adjusted pixels zᵢ, block 512 may include performing filtering and/or processing operations of the input pixels xᵢ.

Block 514 may be applied to operate on columns of the adjusted pixels zᵢ. In embodiments, the column-wise filtering process of block 514 includes identifying and extracting first pixels of the base image in at least one first window sliding along at least one column of the base image to produce a first filtered image. For example, the column-wise filtering process includes processing subsets of the base pixels (e.g., adjusted pixels zᵢ) of each column selected by first and second sliding windows of different sizes (e.g., first window 308, second window 310) to generate a plurality of column-processed pixels. In embodiments, the column-wise filtering process may include identifying and/or extracting the input pixels xᵢ in a moving window along each column to yield an output pixel value (e.g., for each input pixel xᵢ in each column of the input or base image, perform vertical processing of the pixels in a 1D odd-length window centered at that pixel).

Block 516 may be applied to operate on rows of the adjusted pixels zᵢ. In embodiments, the row-wise filtering process of block 516 includes identifying and extracting second pixels of the base image in at least one second window sliding along at least one row of the base image to produce a second filtered image. For instance, the row-wise filtering process includes processing subsets of the base pixels (e.g., adjusted pixels zᵢ) of each row selected by third and fourth sliding windows of different sizes (e.g., third window 314, fourth window 316) to generate a plurality of row-processed pixels. In embodiments, the row-wise filtering process may include identifying and/or extracting the input pixels xᵢ in a moving window along each row to yield an output pixel value (e.g., for each input pixel xᵢ in each row of the input or base image, perform horizontal processing of the pixels in a 1D odd-length window centered at that pixel).

Each of the column-wise and row-wise filtering processes may include performing multiple filtering operations of the base image/pixels. For example, the column-wise filtering process of block 514 may include processing the subsets of the base pixels of each column selected by first and second sliding windows 308, 310 to generate a plurality of first and second processed pixels, respectively. Similarly, the row-wise filtering process of block 516 may include processing the subsets of the base pixels of each row selected by third and fourth sliding windows 314, 316 to generate a plurality of third and fourth processed pixels, respectively.

As shown, a first filtering operation of base pixels may be performed at blocks 522 and 524. For example, at block 522, a long filter may be applied vertically (e.g., on columns using second sliding window 310), and at block 524, a long filter may be applied horizontally (e.g., on rows using fourth sliding window 316). Similarly, a second filtering operation of base pixels may be performed at blocks 528 and 530. For instance, at block 528, a short filter may be applied vertically (e.g., on columns using first sliding window 308), and at block 530, a short filter may be applied horizontally (e.g., on rows using third sliding window 314). In embodiments, the long and short filters in each dimension may be performed in parallel, although other configurations are contemplated.

The long filter operations may be performed using a first vector size (e.g., a 1×5 vector size of FIG. 3, described above) to produce a long filter output image (e.g., long-filtered processed pixels m_{L}). In embodiments, the long filter may produce the long-filtered processed pixels m_{L} per the equation below. At each pixel index i:

$${m}_{L} = N - pt one - dimensional mean centered at {x}_{i} , ( has unity gain ) .$$

Alternatively, the long-filtered processed pixels m_{L} may be produced per the equations below (or any other rounding method to make m_{L} an integer), at each pixel index i:

$$define the fractional parameter invN = \frac{1}{N} ,$$

$${Nm}_{L} = N - pt one - dimensional sum centered {x}_{i} ,$$

$${m}_{L} = floor ( invN * N {m}_{L} )$$

The short filter operations may be performed using a second vector size (e.g., a 1×3 kernel size of FIG. 3, described above) smaller than the first vector size to produce a short filter output image (e.g., short-filtered processed pixels m_{S}). In embodiments, the short filter may produce the short-filtered processed pixels m_{S} per the equation below. At each pixel index i:

$${m}_{s} = \frac{( {x}_{i - 1} + 2 {x}_{i} + {x}_{i + 1} )}{4} , ( has unity gain ) .$$

In block 534, block 514 may include computing one or more vertical pixel sigmas. In block 536, block 516 may include computing one or more horizontal pixel sigmas. For example, block 534 may use input pixels xᵢ and the output from block 522 (i.e., M_{L} calculated through the first filtering operation) to compute a 1D vertical sigma σ_{V}. Likewise, block 536 may use input pixels xᵢ and the output from block 524 (i.e., m_{L} calculated through the second filtering operation) to compute a 1D horizontal sigma σ_{H}. In embodiments, blocks 534 and 536 may be performed in parallel, although other configurations are contemplated. In embodiments, the pixel sigmas may be calculated at each pixel index i based on the following:
σ=N-pt one-dimensional mean of absolute differences between each pixel in the window and the m_{L} at the window's center.
   Alternatively, the pixel sigmas (i.e., m_{L}) may be computed per the equations below (or any other rounding method to make σ an integer), at each pixel index i:

$$define the fractional parameter invN = \frac{1}{N} ,$$

N_{σ}=N-pt one-dimensional mean of absolute differences between each pixel in the window and the m_{L} at the window's center,

$$σ = floor ( invN * {N}_{σ} )$$

The computations of the pixel sigmas illustrated above are illustrative only, and other computations are contemplated. For example, the pixel sigmas may be calculated based on a standard deviation, such as the square root of the mean of the squared differences from the mean.

With continued reference to FIG. 5, each of the column-wise filtering process of block 514 and the row-wise filtering process of block 516 may include combining (e.g., linearly) the long-filtered processed pixels m_{L}, the short-filtered processed pixels m_{S}, and the base image/pixels to produce a blended image. For example, m_{L} from block 522, m_{S} from block 528, and input pixels xᵢ may be combined in block 514 to produce a first blended image vᵢ. In like manner, m_{L} from block 524, m_{S} from block 530, and input pixels xᵢ may be combined in block 516 to produce a second blended image hᵢ.

In embodiments, the blending may be based on one or more weighting factors. For example, the column-wise filtering process may include weighting m_{L} from block 522 and m_{S} from block 528 to generate the column-processed pixels. In like manner, the row-wise filtering process may include weighting m_{L} from block 524 and m_{S} from block 530 to generate the row-processed pixels. In block 542, block 514 may include computing first weighting factors (e.g., three vertical weighting factors) using vertical sigma σ_{V} and one or more vertical epsilons. Similarly, in block 544, block 516 may include computing second weighting factors (e.g., three horizontal weighting factors) using horizontal sigma σ_{H} and one or more horizontal epsilons.

The vertical and horizontal epsilons may include multiple epsilons, such as three epsilons ε₃, ε₄, and ε₅. ε₄ may modify how the short-filter output is blended with the input image/frame. For example, ε₄ may be set to 0 for 100% input frame and set to an increasingly larger number to use more of short-filter output. The larger the associated sigma (e₄), the more of the input image/frame and the less of the short-filter output is used, thereby reducing the amount of blur at the pixel. ε₅ may modify how the long-filter output is blended with the input image/frame. For example, ε₅ may be set to 0 for 100% input frame and set to an increasingly larger number to use more of long-filter output. The larger the associated sigma (e₅), the more of the input image/frame and the less of the long-filter output is used, thereby reducing the amount of blur at the pixel. ε₃ may control blending of the modified short-filtered output and the modified long-filtered output. For example, ε₅ may be set to 0 for 100% modified short-filtered output and set to an increasingly larger number to use more of modified long-filter output. The larger the associated sigma (e₃), the more of the modified short-filter output and the less of the modified long-filter output is used. The three weighting factors may include a first weighting factor w_{L} associated with the first filter output image (i.e., m_{L} from block 522 or m_{L} from block 524), a second weighting factor w_{S} associated with the second filter output image (i.e., m_{S} from block 528 or m_{S} from block 530), and a third weighting factor w associated with the base image (i.e., input pixels xᵢ).

The epsilons and weighting factors may be calculated, at each pixel index i, according to the following equations:

$${e}_{3} = \frac{1}{σ + {ε}_{3}} ,$$

$${e}_{4} = \frac{1}{σ + {ε}_{4}} ,$$

$${e}_{5} = \frac{1}{σ + {ε}_{5}} ,$$

$${w}_{L} = ( {ε}_{3} * {ε}_{5} ) * {e}_{3} * {e}_{5} ,$$

$${w}_{S} = {ε}_{4} * σ * {e}_{3} * {e}_{4} ,$$

$$w = 1 - ( {w}_{L} + {w}_{S} ) .$$

Alternatively, the weighting factors may be calculated, at each pixel index i, according to the following equations:

$${w}_{L} = ( {ε}_{3} * {ε}_{5} ) * ( σ + {ε}_{4} ) ,$$

$${w}_{S} = {ε}_{4} * ( σ + {ε}_{3} ) * σ ,$$

$$w = ( {ε}_{3} * ( σ + {ε}_{4} ) * σ ) + ( ( σ + {ε}_{5} ) * {σ}^{2} ) ,$$

$$d = ( σ + {ε}_{3} ) * ( σ + {ε}_{4} ) * ( σ + {ε}_{5} ) .$$

The filtered and input images may be blended in many configurations. For example, block 514 may use the vertical weighting factors calculated in block 542 to linearly combine the two vertical filter outputs (i.e., m_{L} from block 522 and m_{S} from block 528) and the base image (i.e., input pixels xᵢ). For instance, vertical weighting factor w may be applied to the base image at block 550, vertical weighting factor w_{L} may be applied to the vertically long-filtered output image (i.e., m_{L} from block 522) at block 552, and vertical weighting factor w_{S} may be applied to the vertically short-filtered output image (i.e., m_{S} from block 528) at block 554. In embodiments, the vertically long-filtered output image and the vertically short-filtered output image may be combined at block 558 and then combined with the base image at block 560 to produce first blended image vᵢ. In embodiments, first blended image vᵢ may be produced based on one or more averages over M values, using the following alternative equations, at each pixel index i:

$${v}_{i} = {x}_{i} * M - pt mean of ( w ) + M - pt mean of ( {w}_{L} * {m}_{L} + {w}_{S} * {m}_{S} ) , or$$

$${v}_{i} = {x}_{i} * M - pt mean of ( \frac{w}{d} ) + M - pt mean of ( \frac{{w}_{L} * {m}_{L} + {w}_{S} * {m}_{S}}{d} ) .$$

Similarly, block 516 may use the horizontal weighting factors calculated in block 544 to linearly combine the two horizontal filter outputs (i.e., m_{L} from block 524 and m_{S} from block 530) and the base image (i.e., input pixels xᵢ). For instance, horizontal weighting factor w may be applied to the base image at block 566, horizontal weighting factor w may be applied to the horizontally long-filtered output image (i.e., m_{L} from block 524) at block 568, and horizontal weighting factor w_{S} may be applied to the horizontally short-filtered output image (i.e., m_{S} from block 530) at block 570. In embodiments, the horizontally long-filtered output image and the horizontally short-filtered output image may be combined at block 572 and then combined with the base image at block 574 to produce second blended image hᵢ. In embodiments, second blended image hᵢ may be produced based on one or more averages over M values, using the following alternative equations, at each pixel index i:

$${h}_{i} = {x}_{i} * M - pt mean of ( w ) + M - pt mean of ( {w}_{L} * {m}_{L} + {w}_{S} * {m}_{S} ) , or$$

$${h}_{i} = {x}_{i} * M - pt mean of ( \frac{w}{d} ) + M - pt mean of ( \frac{{w}_{L} * {m}_{L} + {w}_{S} * {m}_{S}}{d} ) .$$

In block 578, process 500 includes combining the column-processed pixels and the row-processed pixels, such as combining first blended image vᵢ and second blended image hᵢ, to produce a smoothed image. For instance, block 578 includes averaging first blended image vᵢ with second blended image hᵢ to produce the smoothed image, although other configurations are contemplated. As described herein, the smoothed image may exhibit reduced detail in relation to the base image.

In block 582, process 500 includes producing a detail image based on a combination of the base image and the smoothed image, the detail image providing enhanced and/or sharpened details in relation to the original image (e.g., enhanced details of scene 170). For example, the detail image may be based on a difference between the smoothed image and the base image. In embodiments, block 582 may include subtracting the smoothed image from the base image to produce the detail image, although other configurations are contemplated.

In embodiments, process 500 includes one or more post-processing processes, such as in a manner as described above with reference to block 440 of FIG. 4. For example, in block 586, process 500 may include scaling the detail image by a gain value 588 to produce a scaled detail image. In block 590, process 500 may include combining the base image with the scaled detail image to produce an enhanced image. In block 592, process 500 may include adjusting the enhanced image by a brightness value 594 to produce an output image yᵢ. In embodiments, at each pixel index i of the smoothed image and a given gain g and a given brightness b, the output image or pixels yᵢ may be calculated according to the following equation:

$${y}_{i} = g ( {x}_{i} - \frac{{v}_{i} - {h}_{i}}{2} ) + {z}_{i} + b$$

In block 596, process 500 includes outputting the output image yᵢ, such as in a manner as described above with reference to block 450 of FIG. 4. For example, output image yᵢ may be outputted to display component 140 of imaging system 100, although other configurations are contemplated. For example, block 596 may include outputting output image yᵢ to a separate device, system, or module.

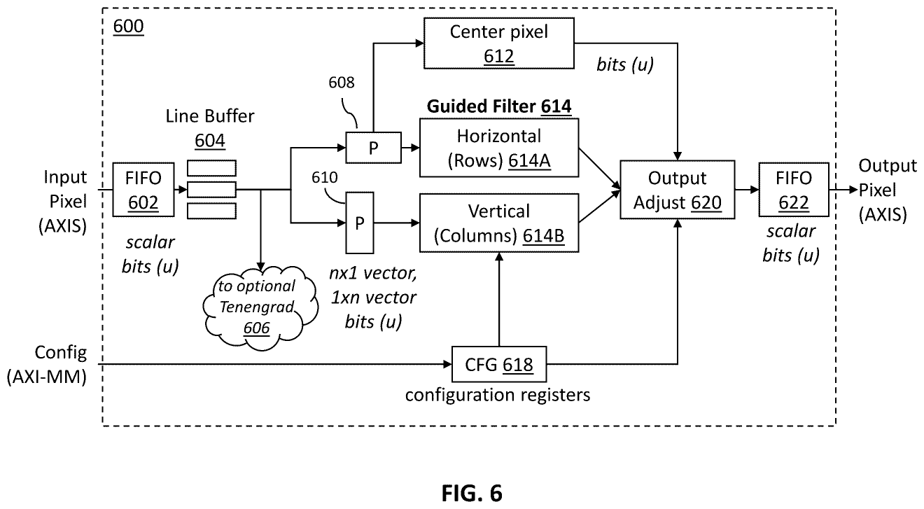

Real-time image enhancement can be implemented through hardware, software, or a combination thereof. Example embodiments of intellectual property (IP) blocks suitable for integration into a hardware system, such as a Field-Programmable Gate Array (FPGA), will now be described with reference to FIGS. 6-12. In various implementations, systems and methods for the real-time adaptive detail enhancement (ADE) of images, which may include Infrared (IR) and/or Electro-Optical (EO) imagery are disclosed. The disclosed systems and methods generate a sharpened image that can be processed and displayed in real-time without substantial delay between image acquisition and image output. The various embodiments of the hardware-based ADE algorithm disclosed herein address implementation issues including latency, line buffers, quantization/rounding, parallel processing, and various implementation configurations. The embodiments disclosed in FIGS. 6-12 may be incorporated with or implemented in the embodiments of FIGS. 1-5, with adaptations tailored for hardware deployment.

The ADE systems and methods of FIG. 6-12 combines unsharp masking and guided filtering, through implementations that achieve improved image enhancement. These embodiments enhance the visual quality of live video compared conventional systems and, in certain implementations, may allow end-users to exercise control over the degree of enhancement (sharpening) applied to an image. In various embodiments, a sharpened image can be generated and seamlessly displayed at the frame rate.

In various embodiments, hardware-based implementations may be adaptable for programming into an Application-Specific Integrated Circuit (ASIC), a Field-Programmable Gate Array (FPGA), or other hardware, allowing systems to deploy real-time video enhancements using the ADE algorithms described herein. In various test implementations, a processing capacity of 300 Mega-pixels per second, a requisite for 4K video, has been verified with potential of processing over 800 Mega-pixels per second for a single video stream processed on end user devices such as cameras. In some implementations, for example, one or more cameras or other devices implementing ADE may be installed on a crewed or uncrewed vehicle (e.g., a land vehicle, aircraft, marine vehicle), capturing images of distant objects that may be characterized by a high dynamic range (e.g., comprising both bright and dark areas). In such implementations, it may be essential to enhance live video in real-time to enhance the visibility and detection of critical details.

An IP Block may be configured to execute localized contrast detail enhancement through the utilization of an ADE guided filter algorithm. Additionally, an optional Tenengrad module, which computes autofocus statistics, may be included as part of the IP Block.

In various embodiments, the hardware implementation provides delay matching to ensure that dependent calculations arrive at the appropriate operators when required. Furthermore, it may be beneficial to capitalize on rounder settings when feasible to mitigate the demand for additional operators and resources. The management of bit precision and fractional bit widths (e.g., spanning from sigma to wL, wS, and w calculations, as described herein) is also a consideration. Implementing cascaded operations involving sigma at multiple stages can introduce complexities in rounding. Additionally, the present disclosure addresses saturation.

In some embodiments, sigma is constrained to a 12-bit representation, utilizing signed arithmetic to facilitate epsilon, sigma, and w calculations across 2 multiplier stages followed by 1 rounder stage. This approach enables the execution of the ADE algorithm, and in some implementations may push the operational boundaries regarding bit precision and quantization error. In this implementation, it is probable that a sigma word length of 12 bits and a fractional length of −3 bits (in accordance with MATLAB fixed-point terminology) may be used to encompass the spectrum of potential sigma values while ensuring compatibility with the native embedded multiplier bit width of 27 bits. The “−3” fractional bits signify that sigma is quantized to always be a multiple of 2\hat{ }3, equating to 8, implying even less precision than with whole numbers or integers. Various examples are illustrated below:

$$sigma register in the FPGA = {12}^{′} b 0000 \_ 0000 \_ 0001 means sigma \\ \\ decimal = 8$$

$$sigma register in the FPGA = {12}^{′} b0000\_ 0001 \_ 0000 means sigma \\ \\ decimal = 128$$

Alternative implementations exist For example: ws=[(epsilon5+sigma)*sigma]*(epsilon4+sigma). In various embodiments, the order of operations may be altered to optimize the utilization of the FPGA or ASIC resources.

FIG. 6 illustrates a top-level block diagram of an example IP block 600, in accordance with embodiments of the present disclosure. This diagram illustrates a data flow within the IP block 600 of a hardware implementation (e.g., an FPGA). As illustrated, First-In, First-Out (FIFO) buffers are provided at the input (FIFO 602) and output (FIFO 622) of the IP block 600 to facilitate availability of ADE processing of video data during operation (e.g., available over 99% of the time in a typical configuration). Additionally, the FIFOs allow the IP block to be compatible with different video data formats, including AXI Streaming or parallel video. The input pixels of an image frame are loaded into the FIFO 602, and subsequently channeled into a line buffer 604. In some embodiments, the line buffer 604 utilizes memory resources, making it a suitable location to introduce additional functions beyond the scope of the ADE algorithm that require a line buffer 604, such as Tenengrad 606 for autofocus.

As illustrated, the video data diverges into three parallel processing paths. A first path introduces delays for the center pixel 612 of the currently processed pixel window. The second path processes horizontal vectors 608 and the third path processes vertical vectors 610. In various embodiments, the number of pixels n in the horizontal vector 608 and vertical vector 610, as well as the pixel color depth in number of bits, is configurable. In some embodiments, configuration registers 618 allow for configuration of the ADE algorithm. For example, configurable “epsilon” coefficients enable fine-tuning of the guided filter 614 performance. The outcomes of the guided filter 614 are used to modify the value of the center pixel 612, based on the settings (e.g., details gain settings) in the configuration register 618.

The guided filter 614 extracts a center pixel and executes operations on horizontal rows 608 through guided filter 614A and vertical columns 610 through guided filter 614B in accordance with one or more configuration registers 618. The blocks responsible for handling horizontal rows (guided filter 614A) and vertical columns (guided filter 614B) subsequently deliver their outputs to an output adjustment block 620. This output adjustment block 620 also receives the center pixel 612 and refines its value based on the outputs from the guided filter 614. The resulting output pixel is directed to another FIFO buffer 622 in preparation for output.

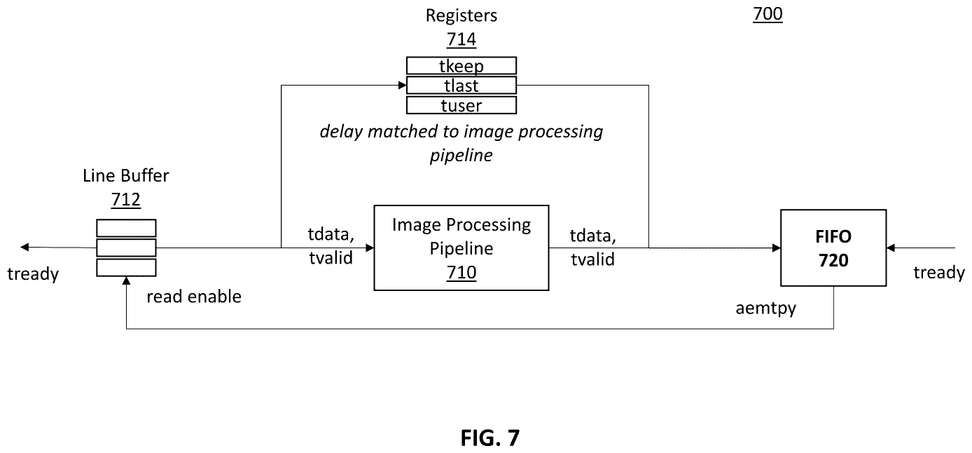

FIG. 7 is a block diagram illustrating example video data streaming IP block, in accordance with one or more embodiments of the present disclosure. In various embodiments, ADE IP may be compliant with the AXI-Streaming standard for video data, or other video data streaming protocols. As illustrated, an IP block 700 includes an image processing pipeline 710 that reads input image data from a line buffer 712 and outputs processed image data to a FIFO 720. The data from the line buffer 712 is processed through the image processing pipeline 710 and includes registers 714 that are delay matched to the image processing pipeline 710.

Various control signals are illustrated which facilitate timing and synchronization between the input from the source system or device and output to the client system or device. In some embodiments, the control signals may be compatible with an AXI Streaming video data format as described below. Other embodiments may use a parallel video data format, or other video data format. The signal TREADY is used to indicate that the client is ready to accept processed image data. The signal TVALID indicates that the data in the stream is valid on the current clock cycle. Together, the values TREADY and TVALID are used to control how fast data can be produced and/or received. When both values are TRUE, the image data TDATA is processed through the IP block 700. The TDATA and TVALID signals move through the image processing pipeline 710. The values TKEEP (is a byte enable signal that indicates that a byte is to be transmitted), TLAST (indicates that a pixel is the last pixel in a line), and TUSER (indicates a start of frame) are delay matched to align with TDATA. Backpressure is applied by TREADY, which indicates whether the client is ready to receive a new frame of image data.

The output FIFO 720 is sized to be able to hold all of the data in the image processing pipeline 710 (e.g., for an image frame). As along as TREADY is high, FIFO 720 will stay mostly empty. If the FIFO 720 starts to fill up (which will happen if the input TREADY goes low), the AEMPTY signal ties to the READ ENABLE signal on the line buffer 712 at the input to the IP Block 700, which will then pull the TREADY output low until the IP Block 700 is ready to process video data again.

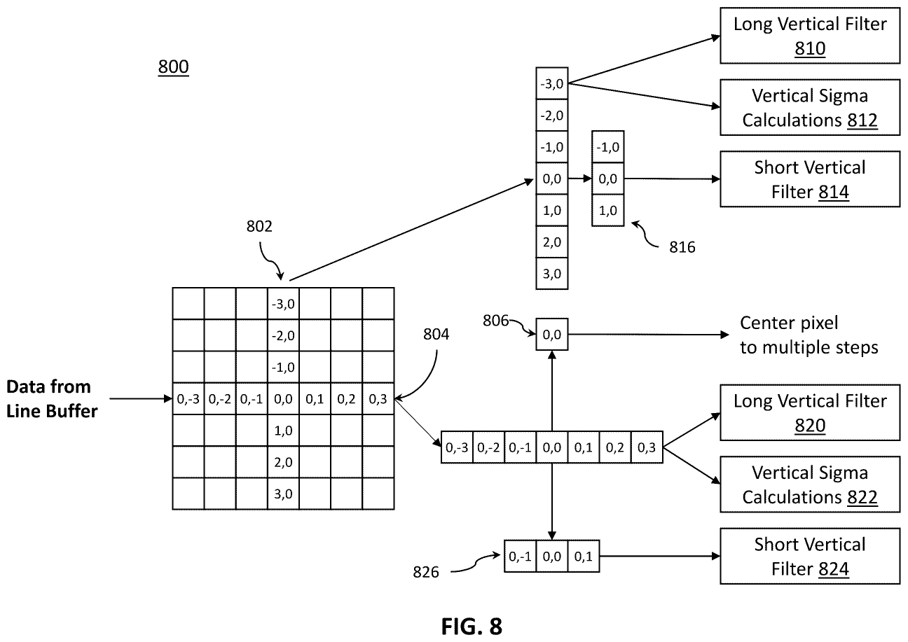

FIG. 8 illustrates an example operation of a guided filter, in accordance with one or more embodiments of the present disclosure. As illustrated, a guided filter 800 uses a center column 802 and center row 804 from the line buffer (e.g., line buffer 604 of FIG. 6, line buffer 712 of FIG. 7, or other line buffer) for calculations. The center column 802 is sent to a long vertical filter 810 and a vertical sigma calculations block 812. The middle of the center column 816 comprises a subset of the center column 802 and is provided to a short vertical filter 814, while the center pixel 806 is used in multiple steps. The center row 804 is sent to a long horizontal filter 820 and a horizontal sigma calculations block 822. The middle of the center row 826 comprises a subset of the center row 804 and is sent to a short horizontal filter 824.

The number of pixels N extracted for the center column 802 and center row 804 is configurable and, in the illustrated embodiments, can be any odd number 5 or greater. For simplicity, the illustrated embodiment uses N=7 and one pixel per clock processing. The processing of various steps can be parallelized (e.g., parallel processing of rows and columns) to support higher data rates.

In operation, N lines of incoming video data is first buffered. In some embodiments, the edges of the frame may be extended by 3 ((N−1)/2) pixels in every direction. Second, a window over the image is defined with a 7×7 (N×N) matrix of pixels. The pixel indices in this matrix are defined relative to the center pixel at p(0,0). For example, the upper left corner is p(−3, −3). Third, for each 7×7 matrix, the IP block extracts: (a) the center pixel, p(0,0); (b) a long horizontal vector [p(−3,0): p(3,0)], such as center row 804, having a length that varies with N; (c) a short horizontal vector [p(−1,0): p(1,0)], having a length that is fixed in the illustrate embodiment (but may vary in other implementations); (d) a long vertical vector [p(0,−3): p(3,0)], such as center column 802, having a length that varies with N; and (e) a short horizontal vector [p(0,−1): p(1,0)], having a length that is fixed in the illustrated embodiment (but may vary in other implementations).

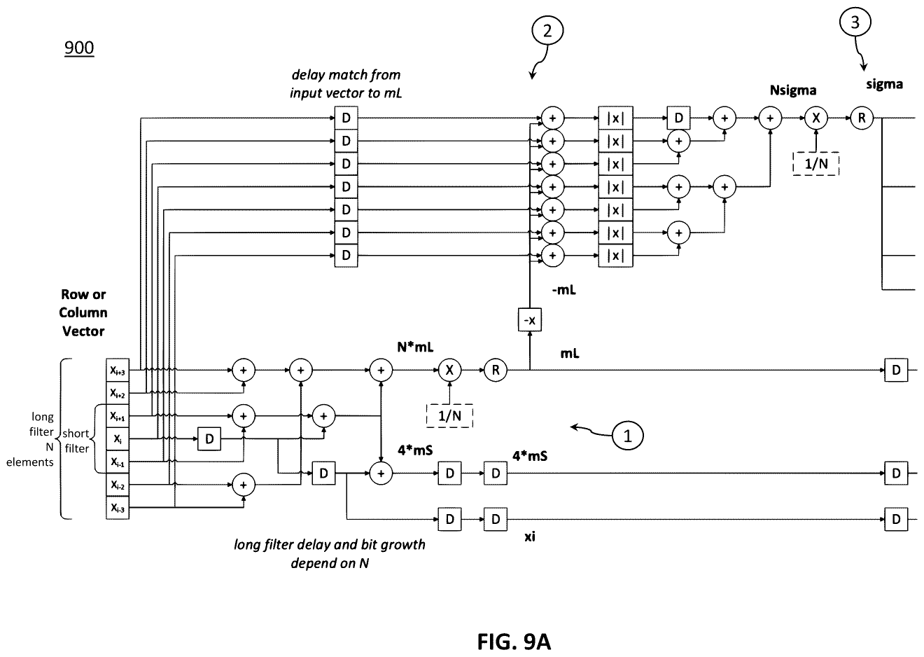

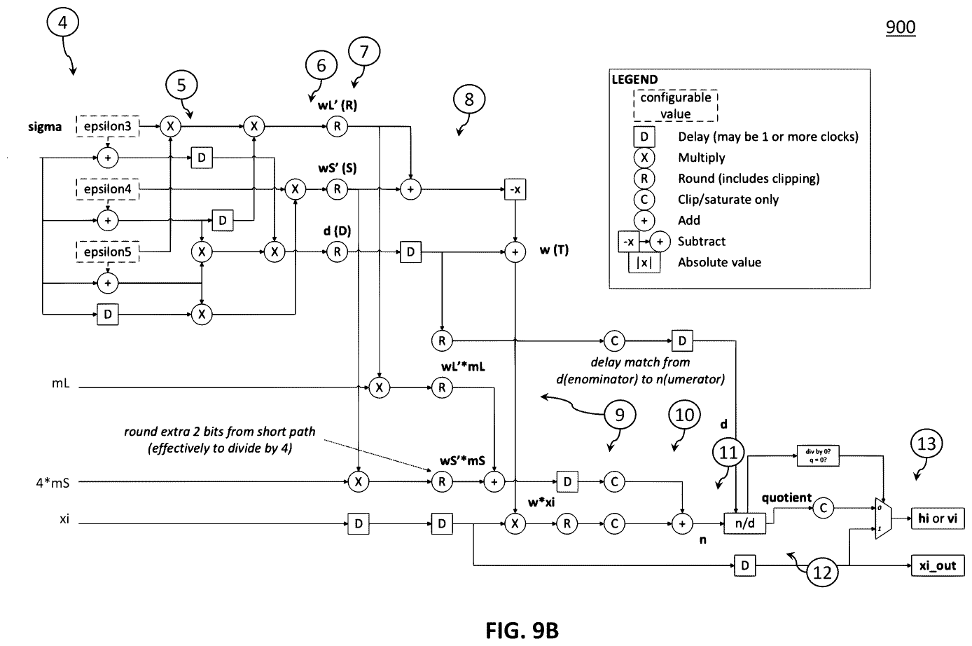

FIGS. 9A and 9B illustrate an example signal flow 900 for both the horizontal guided filter and vertical guided filter, in accordance with one or more embodiments of the present disclosure. The processing system is designed to account for different path lengths (some processing paths have more operations than others), which is addressed through delay elements to match path lengths. The path through sigma calculations to w is the longest in the illustrated embodiment.

An operation of the signal flow 900 will now be described. It will be appreciated that the following steps include processing performed in parallel (e.g., horizontal and vertical processing are performed in parallel).

In step Step 1, various calculations are performed on the row vector and column vector, including: (i) calculate 4*mS=short filter [1,2,1] (dot product); (ii) calculate N*mL=Sum (long filter); and (iii) calculate mL=N*mL*(1/N) and round the result to produce the average of the long filter.

In Step 2, the processing path is delay matched to the long filter calculations in Step 1, and the following calculations are performed: (i) subtract mL from each element of the long filter; (ii) take the absolute maximum of each element; (iii) sum the resulting vector to get N*sigma; and (iv) calculate sigma=N*sigma*(1/N).

In Step 3, sigma is rounded to 12 bits, −3 fractional bits. This makes sigma a fixed-point number that is a multiple of 8 (example: sigma=binary 010 translates to sigma=decimal 16). This step introduces quantization error in order to minimize hardware resources.

In Step 4, epsilon3, epsilon4, and epsilon5 are software-configurable register items, and the following calculations are performed: (i) calculate e3=epsilon3+sigma; (ii) calculate e4=epsilon4+sigma; and (iii) calculate e5=epsilon5+sigma.

In Step 5, delay elements match sigma with the results of Step 4, and the following calculations are performed: (i) calculate eps35=epsilon3*epsilon5; (ii) calculate e5sig=se5*sigma; (iii) calculate e45=e4*e5.

In Step 6, delay elements match sigma with the results of Step 4 and Step 5, and e3 and e4 with Step 5, and the following calculations are performed: (i) calculate wL′=eps35*e4; (ii) calculate wS'=e5sig*epsilon4; and (iii) calculate d=e45*e3.

In Step 7, the results of wL′, wS′, and d are rounded.

In Step 8, mL is delay matched with Steps 2 through 7, 4*mS is delay matched with Steps 2 through 7, and the following calculations are performed: (i) calculate wL′*mL; (ii) calculate wS′*4*mS; and (iii) calculate w=d−wS′.

In Step 9, the center pixel p(0,0) is delay matched with steps 1 through 8, and the following calculations are performed: (i) calculate wxi=w*center pixel; (ii) round wL′*mL; (iii) round wL′*4*mS, by an extra 2 bits to remove the “4” term to get wL′*mS; (iv) round d again (additional rounding to remove all fractional bits).

In Step 10, the following calculations are performed: (i) calculate wm=wS′*mS+wL′*mL; (ii) round wxi.

In Step 11, the following calculation is performed: calculate n=wxi+wm

In Step 12, d is delay matched with steps 10 and 11 and q=n/d is calculated.

In Step 13, the center pixel is delay matched with steps 1 through 12 and if q or d are 0 then the guided filter output=center pixel; otherwise, the guided filter output=q.

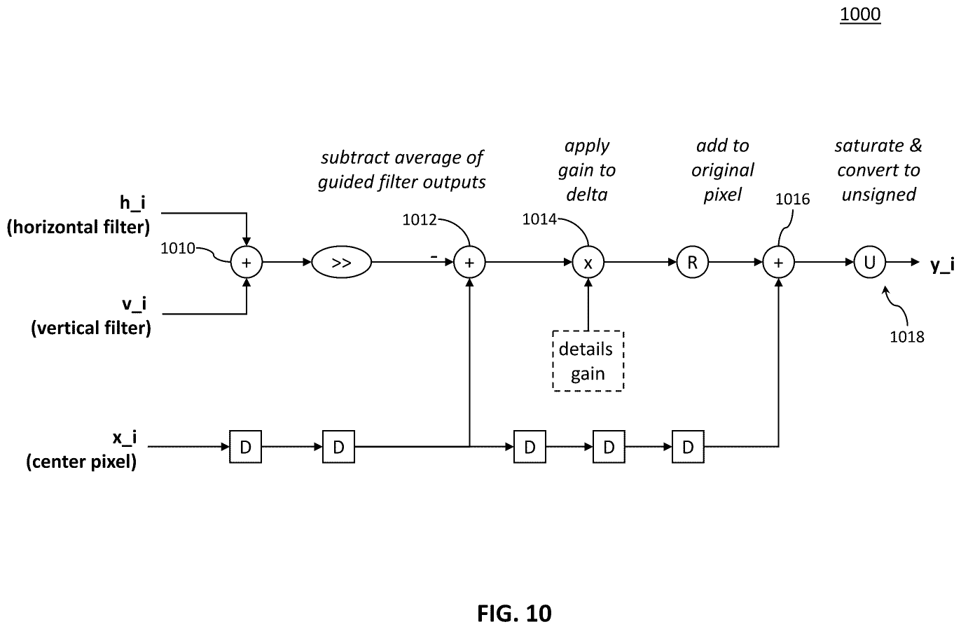

FIG. 10 is a block diagram illustrating example output adjustments including delay elements, in accordance with one or more embodiments. A guided horizontal filter value h_i and a guided vertical filter value v_i are combined at component 1010. The average guided filter outputs are subtracted from a center pixel x_i at component 1012. A gain is applied to the delta at component 1014 and added to the original center pixel value at component 1016. The center pixel value is then saturated and converted to unsigned value, y_i at 1018.

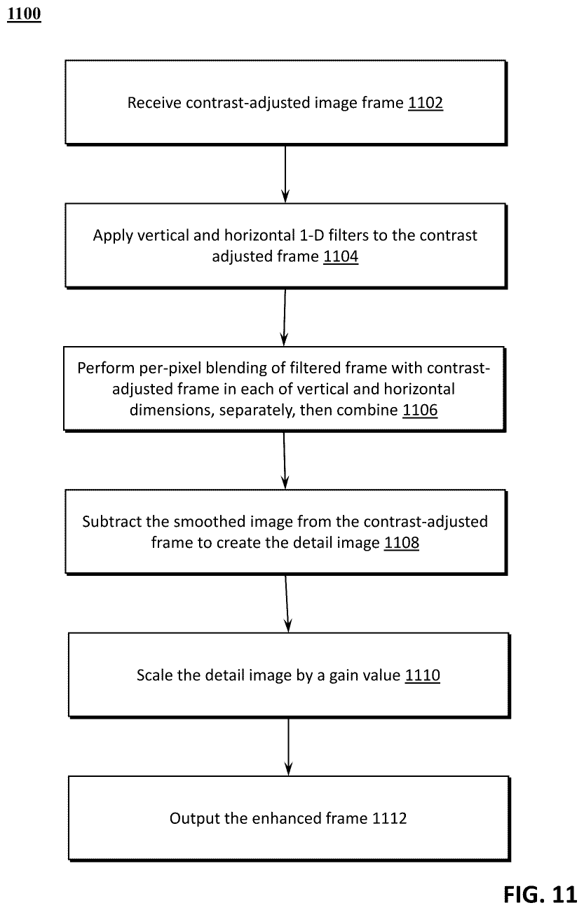

FIG. 11 is a flow diagram illustrating an example operation of ADE processing, in accordance with one or more embodiments of the present disclosure. An ADE algorithm 1100 is based on unsharp masking with a guided filter to achieve superior image enhancement.

In block 1102, a contrast-adjusted image frame is received. The contrast-adjusted image may be generated, for example, as described in accordance with the embodiment of FIG. 4, or through other processes as known in the art.

In block 1104, a guided filter is applied to the contrasted-adjusted image to create an edge-preserving smoothed image. The guided filter may include a vertical guided filter and a horizontal guided filter as described with reference to FIGS. 6-10 and 12, that are calculated in parallel. In block 1106, in accordance with configuration parameters, per-pixel blending of the filtered frame is performed with the contrast-adjusted frame in each of the vertical and horizontal dimensions separately, and then combined.

In block 1106, the smoothed image is subtracted from the contrast-adjusted frame to create a detail image. In block 1108, the detail image is scaled by a configurable gain value. In block 1110, the enhanced frame is output.

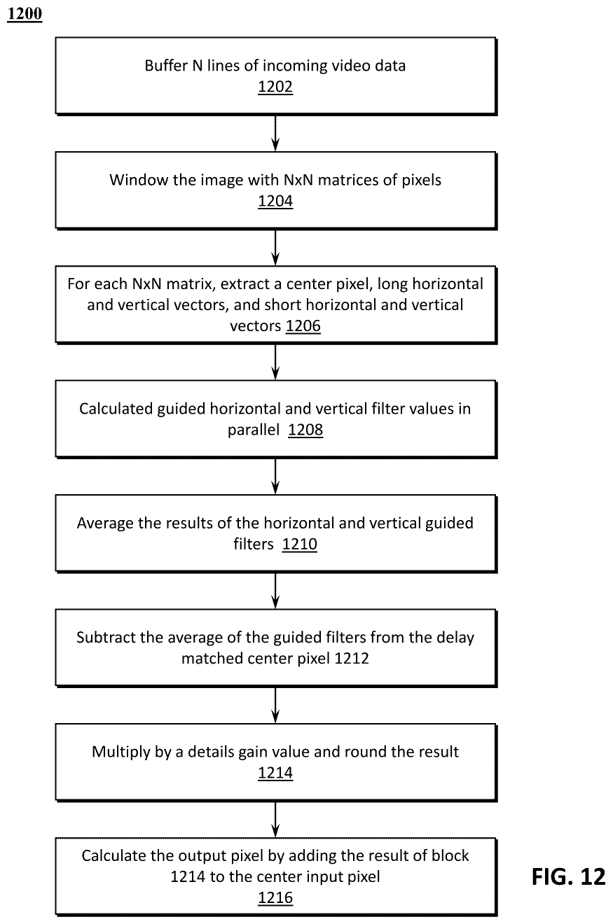

FIG. 12 is a flow diagram illustrating an example guided filter process 1200, in accordance with one or more embodiments of the present disclosure. In block 1202, N lines of incoming video data is buffered. In block 1204, the entire image is windowed over with an N×N matrix of pixels, with the pixel indices in each matrix defined relative to the center pixel at p(0,0).

In block 1206, for each N×N matrix, extract a center pixel, a long horizontal vector of length N, a short horizontal vector comprising a subset of the long horizontal vector centered on the center pixel, a long vertical vector of length N, and a short vertical vector comprising a subset of the long horizontal vector centered on the center pixel.

In block 1208, a horizontal guided filter and a vertical guided filter are calculated in parallel. In block 1210, the results of the horizontal guided filter and vertical guided filter are averaged, and in block 1212, the average of the guided filters is subtracted from the delay matched center pixel.

In block 1214, the result from block 1212 is multiplied by a details gain set by a configuration register and the results are rounded.

In block 1216, the output pixel is processed. The result of block 1214 is added to the delay matched center input pixel, and the result is rounded and clamped to match the bit precision of the input pixel.

Other common image processing tasks such as histogram equalization, brightness and de-noise can further enhance the image when used in conjunction with the embodiments of FIGS. 6-12. In various embodiments, the algorithms are applied to the luminance component of a YUV or YCrCb video stream. The algorithm may also work when applied to all 3 components of an RGB image.

The processes of FIGS. 11 and 12 may be implemented in hardware, software, or a combination of hardware and software. In various embodiments, the processes may be implemented using aspects of the embodiments described in FIGS. 1-10, as appropriate, including as a dedicated IP block as described herein.

As previously discussed, the IP block disclosed herein is configured to perform a guided filter based on an ADE algorithm. The IP block includes a line buffer that takes in a streaming video stream and outputs a row and column vector of pixels. Each vector is processed through a guided filter, and the result is combined with the original input pixel to provide local contrast enhancement and unsharp masking.

In various embodiments, the system may use parameter values to configure the system. Parameters may include a Tenengrad parameter comprising a logic value indicating whether Tenengrad is included in the process; the number of pixels to process per clock cycle (e.g., 1 pixel, 4 pixels, etc.); pixel color depth or component data width; maximum horizontal resolution (pixels in a line), maximum vertical resolution (lines in a frame); filter dimensions, length of short filter, length of long filter; clock periods; different video formats (monochrome, YUV444, YUV422, RGB), and other parameters. The system may be configured to operate on a single pixel (mono color value) or color pixel values. Although the implementations disclosed herein are designed to support 4K video at 60 Hz, the implementations may be adapted to support other video formats and rates.

In test environments, a filter length of 7 has been used to provide generally acceptable results, but may be modified in accordance with implementation goals. In test images of a high dynamic range scene, there was an observable difference in the visibility of details such as cracks in a sidewalk or individual tree branches from N=5 to N=17. The ADE IP performs contrast enhancement and sharpening to bring out image details in high dynamic range scenes that may otherwise be blurry, shadowed, or difficult to see.

Video signals may include a signal to indicate arrival of a new frame, indication of which bytes to keep in the input video data path, indication that incoming video data is valid, indication that the IP block is ready to accept video data, an indication of the last sample in a line, an indication of which bytes to keep in the output video data path, indication that outgoing video data is valid, indication that downstream logic is ready to accept video data, indication of the last sample in a line, and other parameter value and signals.

In various embodiments, the IP block may include one or more configuration registers, which may include registers indicating the version of the IP, image width configuration (horizontal, number of columns), image height configuration (vertical, number of lines or rows), coefficients for guided filter equation (epsilons), unsigned gain to be applied, and other values. In some implementations, not all bits will be used.

U.S. Provisional Patent Application No. 63/406,197 filed Sep. 13, 2022 and entitled “ADAPTIVE DETAIL ENHANCEMENT OF IMAGES SYSTEMS AND METHODS” is incorporated by reference herein in its entirety. U.S. patent application Ser. No. 18/485,820 filed Sep. 12, 2023 and entitled “ADAPTIVE DETAIL ENHANCEMENT OF IMAGES SYSTEMS AND METHODS” is incorporated by reference herein in its entirety. U.S. Pat. No. 9,595,087 issued Mar. 14, 2017 and entitled “IMAGE PROCESSING METHOD FOR DETAIL ENHANCEMENT AND NOISE REDUCTION” is incorporated by reference herein in its entirety. U.S. Pat. No. 10,255,662 issued Apr. 9, 2019 and entitled “IMAGE PROCESSING METHOD FOR DETAIL ENHANCEMENT AND NOISE REDUCTION” is incorporated by reference herein in its entirety.

Where applicable, various embodiments provided by the present disclosure can be implemented using hardware, software, or combinations of hardware and software. Also, where applicable, the various hardware components and/or software components set forth herein can be combined into composite components comprising software, hardware, and/or both without departing from the spirit of the present disclosure. Where applicable, the various hardware components and/or software components set forth herein can be separated into sub-components comprising software, hardware, or both without departing from the spirit of the present disclosure. In addition, where applicable, it is contemplated that software components can be implemented as hardware components, and vice-versa.

Software in accordance with the present disclosure, such as program code and/or data, can be stored on one or more computer readable mediums. It is also contemplated that software identified herein can be implemented using one or more general purpose or specific purpose computers and/or computer systems, networked and/or otherwise. Where applicable, the ordering of various steps described herein can be changed, combined into composite steps, and/or separated into sub-steps to provide features described herein.

Embodiments described above illustrate but do not limit the invention. It should also be understood that numerous modifications and variations are possible in accordance with the principles of the present invention. Accordingly, the scope of the invention is defined only by the following claims.

What is claimed is:

1. A method comprising:
receiving an input image comprising a plurality of pixels arranged in rows and columns;
performing a vertical guided filtering process comprising processing a column of pixels encompassing a center pixel to generate a vertical adjustment value;
performing a horizontal guided filtering process comprising processing a row of pixels encompassing the center pixel to generate a horizontal adjustment value;
adjusting the center pixel value in accordance with the vertical adjustment value and the horizontal adjustment value to generate a smoothed image;
subtracting the smoothed image from the input image to create a detail image; and
outputting an enhanced image.

2. The method of claim 1, wherein the input image is a contrast-adjusted image and the method provides adaptive detail enhancement of the contrast-adjusted image.

3. The method of claim 1, wherein the smoothed image enhances edges from the input image.

4. The method of claim 1, wherein adjusting the center pixel value comprises performing per-pixel blending based at least in part on the vertical adjustment value and the horizontal adjustment value.

5. The method of claim 1, further comprising scaling the detail image by a configurable gain value.

6. The method of claim 5, wherein the enhanced image is generated by combining the scaled detail image with the input image.

7. The method of claim 1, wherein performing a vertical guided filtering process and performing a horizontal guided filtering process are performed in parallel.

8. A system for performing the method of claim 1, comprising an intellectual property block configured to perform the vertical guided filtering process, the horizontal guided filtering process and adjusting the center pixel.

9. A system for performing the method of claim 1, the system comprising:
an image processing block comprising:
a line buffer configured to extract a matrix of pixels from the input image centered on the center pixel;
a guided filter configured to process a horizontal row and a vertical column of pixels from the matrix of pixels; and
an output adjustment block configured to adjust a value of the center pixel based on the outputs of the guided filter.

10. The system of claim 9, wherein the image processing block further comprises:
a first-in, first out (FIFO) input buffer configured to receive pixels of the input image, wherein the line buffer extracts the matrix of pixels from the FIFO input buffer; and
a FIFO output buffer configured to buffer adjusted pixel values for the image for output.

11. The system of claim 9, further comprising a Tenegrad module configured to evaluate pixel values from the line buffer for autofocus processing.

12. The system of claim 9, wherein the guided filter comprises:
a horizontal guided filter configured to filter the horizontal row of pixels; and
a vertical guided filter configured to filter the vertical column of pixels;
wherein the horizontal guided filter and vertical guided filter operate in parallel.

13. A method of operating the system of claim 9, comprising:
loading input pixels of an input image into the line buffer;
processing horizontal vectors of pixels from the line buffer and vertical vectors of pixels from the line buffer in parallel through the guided filter; and
refining the value of the center pixel using the output adjustment block.

14. The system of claim 9, wherein the guided filter comprises:
a long vertical filter configured to process a vertical column of pixels encompassing the center pixel;
a short vertical filter configured to process a subset of the vertical column of pixels;
a long horizontal filter configured to process a horizontal row of pixels encompassing the center pixel; and
a short horizontal filter configured to process a subset of the horizontal row of pixels.

15. The system of claim 9, further comprising a plurality of delay elements implemented one or more processing paths of the image processing block to match processing path lengths to synchronize processing.

16. A system comprising:
a guided horizontal filter;
a guided vertical filter;
an output adjustment module configured to combine the guided horizontal filter value and the guided vertical filter value;
a subtraction component configured to subtract average guided filter outputs from a center pixel to generate a delta;
a gain application module configured to apply a gain to the delta to generate a gain-adjusted delta; and
an addition component configured to add the gain-adjusted delta to the center pixel value.

17. The system of claim 16, further comprising a saturation and conversion module configured to saturate and convert the center pixel value to an unsigned value.

18. The system of claim 16, further comprising delay elements configured to synchronize processing.

19. A method comprising:
buffering lines of incoming image data for an image frame;
windowing over the image frame with an N×N matrix of pixels relative to a center pixel;
extracting the center pixel, a long horizontal vector of length N centered on the center pixel, a short horizontal vector comprising a subset of pixels from the long horizontal vector, a long vertical vector of length N centered on the center pixel, and a short vertical vector comprising a subset of pixels from the long vertical vector;
calculating a horizontal guided filter from the long horizontal vector and the short horizontal vector;
calculating a vertical guided filter in parallel with the calculating the horizontal guided filter from the long vertical vector and the short vertical vector;
averaging the calculated horizontal guided filter and the calculated vertical guided filter;
subtracting the average from the center pixel to generate a delta; and
multiplying the delta by a details gain value and adding to the center pixel value.

20. A system comprising an IP block configured to perform the method of claim 19.
